(19) United States
(12) Patent Application Publication
(10) Pub. No.: US 2022/0113037 A1
(43) Pub. Date: Apr. 14, 2022

(54) COOKING DEVICE AND METHOD FOR CONTROLLING COOKING DEVICE

(71) Applicant: Samsung Electronics Co., Ltd., Suwon-si (KR)

(72) Inventors: Sangjin LEE, Suwon-si (KR); Sangjin KIM, Suwon-si (KR); Myoungkeun KWON, Suwon-si (KR); Eungryeol SEO, Suwon-si (KR)

(21) Appl. No.: 17/419,235

(22) PCT Filed: Apr. 9, 2020
(86) PCT No.: PCT/KR2020/004786

§ 371 Date: Jun. 28, 2021

(30) Foreign Application Priority Data
Apr. 24, 2019 (KR) 10-2019-0047893

(51) Int. Cl. F24C 15/32; F04D 27/00

(52) U.S. Cl. CPC F24C 15/322; F04D 27/00

(57) ABSTRACT

A cooking device according to the present disclosure comprises: a body in which a cooking chamber including an inlet and an outlet is formed; a heater for heating air; a fan configured to selectively change a discharge direction of the heated air to provide the heated air to the cooking chamber; and a processor configured to control a motor to provide a driving force to the fan such that the fan alternately changes the discharge direction, wherein the processor controls the motor such that a predetermined discharge direction among multiple discharge directions is maintained for a longer time than the other discharge directions.

### CROSS-REFERENCE TO RELATED APPLICATIONS

This application is a 371 of International Application No. PCT/KR2020/004786 filed on Apr. 9, 2020, which claims priority to Korean Patent Application No. 10-2019-0047893 filed on Apr. 24, 2019, the disclosures of which are herein incorporated by reference in their entirety.

### BACKGROUND

### 1. Field

The disclosure relates to a cooking device and a method for controlling a cooking device, and particularly to, a cooking device for cooking food and the like using a fan and a method for controlling the cooking device.

### 2. Description of Related Art

The cooking device is a device for cooking food by heating inside of a cooking chamber by circulating the air in the cooking chamber around a heater which generates heat.

In general, the cooking device includes a heater and a fan and cooks food placed in the cooking chamber by repeating a process of introducing the air of the cooking chamber by the fan, heating the air by the heater, and then discharging the air to the cooking chamber again.

In the related art, the fan in the cooking device is controlled in a single direction, and accordingly, the discharge air may have directivity to be biased to one side due to a rotation direction of the fan. Accordingly, a difference may occur in temperature and speed of the discharge air depending on positions of the cooking chamber. In particular, such a difference occurs relatively significantly between right and left sides in the cooking chamber, and accordingly, the food in the cooking chamber may not be evenly cooked or heating stains may be generated on the food.

The disclosure is made in view of the above problems described above, and an object thereof is to provide a cooking device for heating food evenly over the entire cooking chamber and enhancing cooking efficiency and a method for controlling a cooking device.

### SUMMARY

In accordance with an embodiment of the disclosure, there is provided a cooking device including a main body in which a cooking chamber including an inlet and an outlet is formed, a heater configured to heat the air, a fan configured to provide the heated air to the cooking chamber by selectively changing a discharge direction, and a processor configured to control a motor configured to provide a driving force to the fan so that the fan alternately changes the discharge direction, in which the processor is configured to control the motor so that a retention time in a predetermined discharge direction among a plurality of discharge directions is longer than a retention time in another discharge direction.

The predetermined discharge direction may be a first direction of a circumferential direction of the fan, and the other discharge direction may be a second direction opposite to the first direction.

The fan may include a rotation plate configured to be located to be adjacent to one side of the main body and a center portion of which is fastened to a motor for driving the fan, and a plurality of blades radially extending from the rotation plate, each of the plurality of blades may include a vertical portion configured to be formed on one side to be vertical to the rotation plate, and an empty space configured to be formed on the other side, the first direction may be a direction of the vertical portion, and the second direction may be a direction of the empty space.

The processor may be configured to control the motor so that a retention time in the first direction is two or more times longer than a retention time in the second direction.

The processor may be configured to control the motor so that the discharge direction of the fan alternately changes two or more times in a predetermined section.

The processor may be configured to control the motor so that the fan rotates in the first direction before the predetermined section until a temperature of the cooking chamber reaches a set preheating temperature.

The processor may be configured to, based on the temperature of the cooking chamber reaching the set preheating temperature, control the motor so that the fan rotates in the first direction during a predetermined time.

The processor may be configured to, based on the predetermined time being elapsed, control the motor so that the fan alternately changes the discharge direction during the predetermined section.

The fan may be configured to discharge the air flowing in an axial direction of the rotation plate in a circumferential direction of the plurality of blades.

The cooking device may further include a cover configured to form a space partitioned from the cooking chamber in the main body and cover the heater and the fan, and the inlet and outlet may be formed on the cover.

The inlet may be formed in a circular shape at a positon corresponding to the center portion of the rotation plate, and the outlet may be formed bilaterally symmetrical with respect to the inlet.

The vertical portion may be formed by folding one side of each of the plurality of blades.

The plurality of empty spaces may be formed by the folded vertical portions.

In accordance with another embodiment of the disclosure, there is provided a method for controlling an electronic device, the method including preheating a cooking chamber so that a temperature of the cooking chamber including an inlet and an outlet reaches a set temperature, performing resting by stopping a heater for heating the air during a predetermined time, and discharging the air in a first direction by the fan for providing the heated air to the cooking chamber, in order to circulate the air inside of the cooking chamber, and controlling a temperature by operating the heater intermittently in order to maintain a temperature of the inside of the cooking chamber constant, in which, in the controlling the temperature, the fan alternately changes a discharge direction and a retention time in a predetermined discharge direction among a plurality of discharge directions is longer than a retention time in another discharge direction.

The predetermined discharge direction may be a first direction of a circumferential direction of the fan and the other discharge direction may be a second direction opposite to the first direction.

In the controlling the temperature, a first direction rotation time of the fan may be two or more times longer than a second direction rotation time of the fan.

In the controlling the temperature, the fan may change a rotation direction before the heater is operated.

In the preheating, the heater may be continuously operated and the fan may rotate in the first direction.

The cooking device and the method for controlling the cooking device of the disclosure may heat the food evenly over the entire cooking chamber and enhance cooking efficiency.

### BRIEF DESCRIPTION OF THE DRAWINGS

FIG. 1 is a perspective view of a cooking device according to an embodiment;

FIG. 2 is a block diagram illustrating a schematic configuration of the cooking device according to an embodiment;

FIG. 3 is a cross-sectional view of the cooking device according to an embodiment;

FIG. 4 is an exploded perspective view of a cover, a fan, and a heater according to an embodiment;

FIG. 5 is a perspective view of a fan according to an embodiment;

FIG. 6 is a schematic view illustrating a flow of air discharged, when the fan rotates in a first direction according to an embodiment;

FIG. 7 is a schematic view illustrating a flow of the air discharged, when the fan rotates in a second direction according to an embodiment;

FIG. 8 is a graph illustrating operations of the fan and the heater according to an embodiment;

FIG. 9 is a schematic view illustrating a flow of the air discharged, when fans rotate in the same direction according to another embodiment;

FIG. 10 is a schematic view illustrating a flow of the air discharged, when the fans illustrated in FIG. 9 rotate in different directions; and

FIG. 11 is a flowchart illustrating a method for controlling the cooking device according to an embodiment.

### DETAILED DESCRIPTION

Hereinafter, embodiments of a cooking device and a method for controlling a cooking device according to the disclosure will be described in detail with reference to the accompanying drawings.

The embodiments described below are exemplified for understanding of the disclosure and it should be understood that the disclosure may be modified and performed variously unlike in the embodiments described herein. However, in describing the disclosure, a detailed description of the related art or configuration may be omitted when it is determined that the detailed description may unnecessarily obscure a gist of the disclosure. In addition, the accompanying drawings may not be illustrated with actual scales but may be illustrated with enlarged dimensions of some elements, for the understanding of the disclosure.

The terms “first,” “second,” or the like may be used for describing various elements but the elements may not be limited by the terms. The terms are used only to distinguish one element from another. For example, a first element may be referred to as a second element and the second element may also be similarly referred to as the first element, while not departing from the scope of a right of the disclosure.

The terms used in the embodiments of the disclosure may be interpreted as meanings known to those skilled in the art, unless otherwise defined.

In addition, the terms used in the disclosure such as “top”, “bottom”, “front end”, “rear end”, “upper portion”, “lower portion”, “upper end”, “lower end”, and the like are defined based on the drawings, and these terms are not for limiting a shape and a position of each constituent element.

Hereinafter, the disclosure will be described in detail with reference to the accompanying drawings.

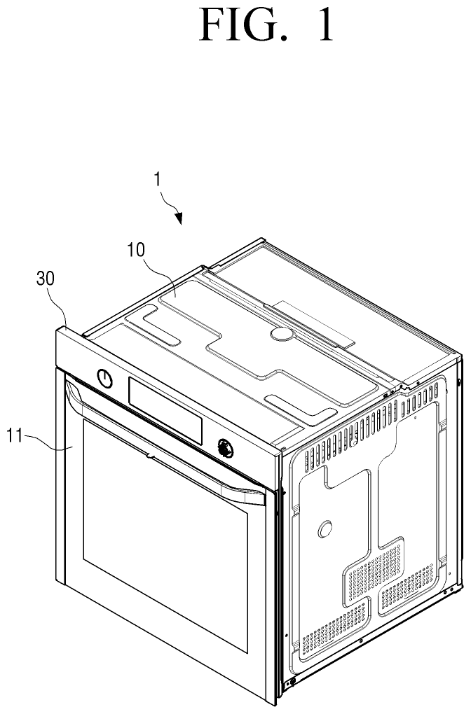

FIG. 1 is a perspective view of a cooking device according to an embodiment.

Referring to FIG. 1, a cooking device 1 may form an appearance by including a main body 10 formed in a box shape in which a front part is open, and a door 11 hinge-coupled to a lower end portion of the main body 10 so as to open and close the open front part of the main body 10.

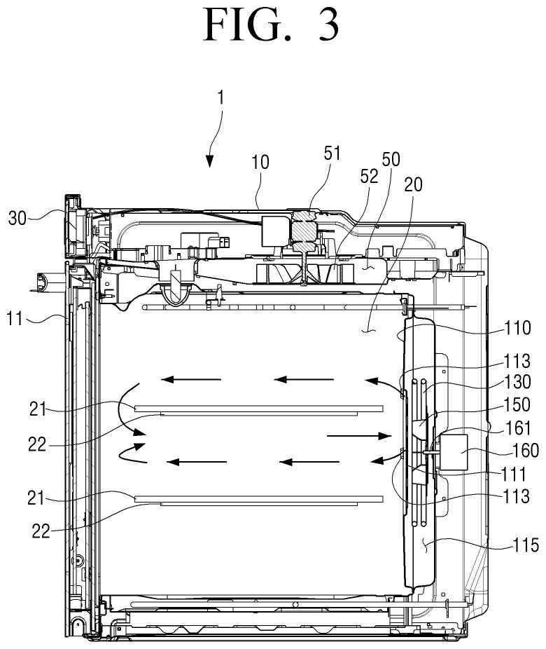

A cooking chamber 20 (see FIG. 3) in which food may be placed to be cooked may be provided in the main body 10. An inputter 30 on which various buttons and switches and a display are installed may be disposed on an external upper portion of the main body 10 so as to select a type of cooking and control a cooking time, a cooking process, and the like.

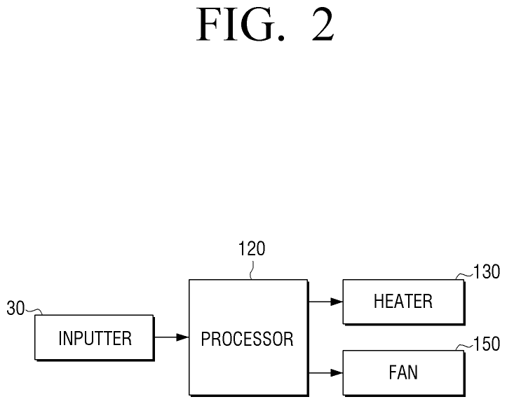

FIG. 2 is a block diagram illustrating a schematic configuration of the cooking device according to an embodiment.

Referring to FIG. 2, the cooking device 1 may include the inputter 30 for receiving an operation command of the cooking device 1 from a user, a heater 130 for heating the air of the cooking chamber 20, a fan 150 for circulating the air heated by the heater 130, and a processor 120 for controlling the operations of the cooking device 1.

The inputter 30 may receive a function command related to the control of the cooking device 1 from the user and output an electric signal corresponding to the function command input from the user to the processor 120.

The processor 120 may control the operations of the cooking device 1. Specifically, the processor 120 may control the operations of the heater 130 and the fan 150.

The processor 120 may control a motor 160 for providing a driving force to the fan 150 so that the fan 150 alternately changes an air discharge direction so that the heated air to be supplied to the cooking chamber 20 has even temperature and speed distribution over the entire cooking chamber 20.

The processor 120 may control the motor so that a retention time of a predetermined discharge direction among a plurality of discharge directions is longer than a retention time of another discharge direction. The predetermined discharge direction is a rotation direction with higher energy efficiency than other discharge directions.

The processor 120 may control the motor 160 so that a retention time of the fan 150 in a first direction is two or more times longer than a retention time of the fan 150 in a second direction.

The processor 120 may control the motor 160 so that the discharge direction of the fan 150 is alternately changed two or more times in a predetermined section.

In addition, until a temperature of the cooking chamber 20 reaches a set preheating temperature before the predetermined section and when the temperature of the cooking chamber 20 reaches the set preheating temperature, the processor 120 may control the motor 160 so that the fan 150 rotates in the first direction during a predetermined time.

Hereinafter, the specific configuration of the cooking device 1 will be described.

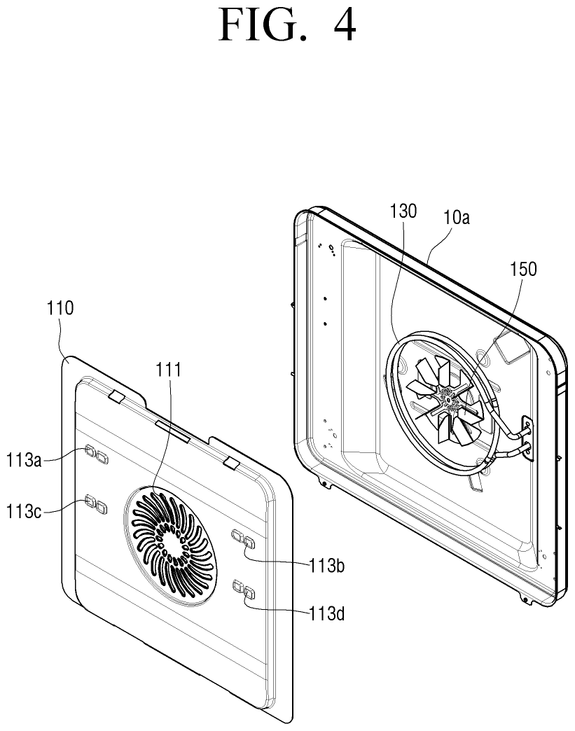

FIG. 3 is a cross-sectional view of the cooking device according to an embodiment and FIG. 4 is an exploded perspective view of a cover, a fan, and a heater according to an embodiment.

Referring to FIGS. 3 and 4, in the cooking chamber 20, a tray 21 may be detachably provided so that food to be cooked is able to be placed inside thereof, and guide rails 22 may be installed on both side surfaces of the cooking chamber 20 so as to support the tray 21. Referring to FIG. 3, the tray 21 may be configured with a plurality of pieces and the guide rails 22 may be configured with at least one pair. In particular, the guide rails 22 may be provided with a plurality of pairs at various heights so as to variously adjust an installation height of the tray 21.

A cover 110 for forming a chamber space 115 partitioned from the cooking chamber 20 may be provided in the main body 10.

In the chamber space 115, the heater 130 for heating the air of the cooking chamber 20 and the fan 150 for circulating the air heated by the heater 130 may be disposed.

The heater 130 may be formed in a circular shape along a border of the fan 150 and radiate heat. The heater 130 may be installed on a rear surface 10a (see FIG. 4) of the main body 10 to heat the air of the chamber space 115. The heater 130 according to an embodiment of the disclosure may be formed in a circular shape but may be formed in various shapes, without any limit.

The fan 150 may be installed in the heater 130 to allow the air heated by the heater 130 to forcibly flow to the cooking chamber 20. The fan 150 may supply hot air to the food and the like contained in the cooking chamber 20 and forcibly circulate the air in the cooking chamber 20 to promote heat transfer.

The motor 160 for driving the fan 150 may be provided in a rear portion of the fan 150. The motor 160 may be disposed on an outer side of a rear surface 10a of the main body. The motor 160 may generate a rotation power by an applied power to rotate the fan 150 which is fastened to a motor shaft 161.

The fan 150 may rotate by receiving the rotation force from the motor 160 and circulate the internal air of the cooking chamber 20. Specifically, the fan 150 provided on the rear surface of the cooking chamber 20 may discharge the air towards the front portion of the cooking chamber 20, and the air discharged towards the front portion of the cooking chamber 20 by the fan 150 may circulate the inside of the cooking chamber 20 and return to the fan 150 again, as illustrated in FIG. 3.

The motor 160 may rotate forward and reversely so that the fan 150 is able to rotate in both directions of the first direction and the second direction.

The fan 150 according to an embodiment of the disclosure may discharge the heated air into the cooking chamber 20 evenly, since the air inside of the cooking chamber 20 may be circulated by the rotation in both directions. The air discharged as described above may heat the food at an even wind speed over the entire food inside of the cooking chamber 20. The specific driving of the fan 150 for supplying the heated air evenly over the entire cooking chamber 20 will be described later.

The cover 110 may be disposed to be spaced apart from the rear surface 10a of the main body and provided to cover the fan 150. The cover 110 may include an inlet 111 and an outlet 113 connected to the cooking chamber 20.

The inlet 111 may be formed with a plurality of pieces at positions corresponding to the front side of the fan 150 to suck in the air forcibly flowing by the fan 150.

The outlet 113 may be formed with a plurality of pieces at positions corresponding to the side border of the fan 150 to discharge the air heated by the heater 130 to the cooking chamber 20.

The outlet 113 may be configured with upper outlets 113a and 113b provided on the upper side with respect to the inlet 111 and lower outlets 113c and 113d provided on the lower side.

The outlets 113 may be disposed to be bilaterally symmetrical with respect to the inlet 111.

Specifically, the upper outlet 113a disposed on the left side of the inlet 111 may be disposed to be symmetrical to the upper outlet 113b disposed on the right side thereof, and the lower outlet 113c disposed on the left side of the inlet 111 may be disposed to be symmetrical to the lower outlet 113d disposed on the right side thereof.

Since the outlets 113 are formed to be bilaterally symmetrical with respect to the cover 110, the evenness of the internal temperature of the cooking chamber 20 may be enhanced. In addition, the air supplied to the cooking chamber 20 via the outlets 113 formed in bilaterally symmetrical manner, may cook the food evenly.

The air in the cooking chamber 20 may be sucked into the chamber space 115 from the inlet 111 by the rotation of the fan 150, and at the same time, the air heated by the heater 130 in the chamber space 115 may be supplied into the cooking chamber 20 via the outlets 113 as hot air, and the food may be heated and cooked by the air supplied into the cooking chamber 20.

An exhaust space 50 for discharging gas or particles generated inside of the cooking chamber 20 to the outside may be formed on the upper portion of the inside of the main body 10. An exhaust fan 52 for discharging the air in the cooking chamber 20 may be disposed in the exhaust space 50, and an exhaust fan motor 51 for driving the exhaust fan 52 may be installed on a rear portion of the exhaust fan 52.

At least one inlet (not illustrated) may be formed on the upper portion of the main body opposing the exhaust fan 42 so as to suck in the air in the cooking chamber 20, and the air flowing into the exhaust space 50 by the inlet (not illustrated) may be mixed with external cold air and discharged to the outside due to the air flow formed by the rotation of the exhaust fan 52.

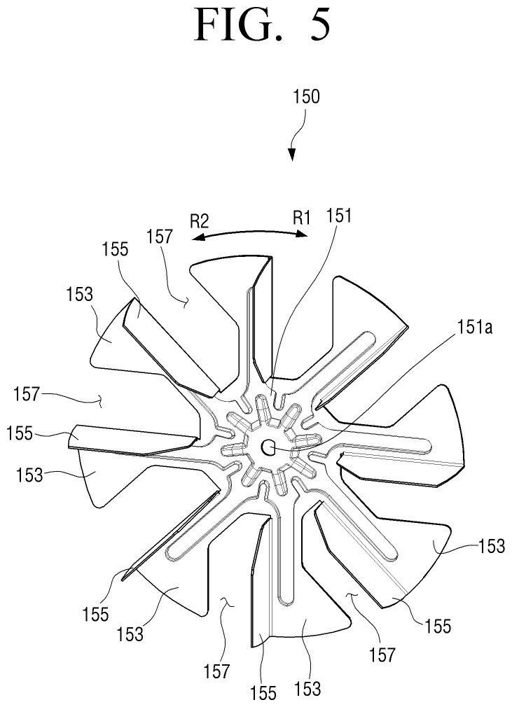

FIG. 5 is a perspective view of a fan according to an embodiment.

Referring to FIG. 5, the fan 150 may include a circular rotation plate 151, and a plurality of blades 153 extending radially from the rotation plate 151. A center portion 151a coupled with the motor shaft 161 may be formed at the center of the rotation plate 151. The motor shaft 161 may be connected to the center portion 151a of the rotation plate so that the rotation plate 151 and the motor 160 may be connected so as to rotate in the same direction. Therefore, if the motor 160 rotates in the first direction, the fan 150 may rotate in the first direction together with the motor 160, and if the motor 160 rotates in the second direction, the fan 150 may rotate in the second direction.

The rotation plate 151 may be installed to be adjacent to the rear surface 10a of the main body 10 and may be formed to be substantially flat to be disposed in parallel to the rear surface 10a.

The blade 153 for discharging the air to the front portion, when the fan 150 rotates, may be radially formed to extend from the center portion 151a so as to rotate in both directions.

Each of the plurality of blades 153 may include a vertical portion 155 formed on one side and an empty space 157 formed on the other side.

The vertical portion 155 may be formed vertically to the rotation plate 151 and the empty space 157 may be formed between adjacent blades 153 among the plurality of blades 153.

In an example, the vertical portion 155 of the blade 153 may be formed by folding a part of the rotation plate 151 along a predetermined line of the rotation plate 151, and the plurality of empty spaces 157 may be formed by the folded vertical portions 155.

The fan 150 may rotate in a first direction R1 which is the direction of the vertical portion 155 and rotate in a second direction R2 which is the direction of the empty space 157.

Meanwhile, the energy efficiency when the fan 150 rotates in the first direction R1 which is the direction of the vertical portion 155 by the vertical direction 155 pushing the air, when the fan 150 rotates, may be higher than the energy efficiency when the fan 150 rotates in the second direction R2 which is the direction of the empty space 157. The specific driving of the fan 150 with the difference in energy efficiency between the rotation in the first direction R1 and the rotation in the second direction R2 will be described later.

The fan 150 may be driven so as to selectively change the discharge direction of the heated air. Specifically, the fan 150 may alternately rotate in the first direction R1 and the second direction R2.

Since the fan 150 alternately rotates in the first direction R1 and the second direction R2, the discharge direction of the air discharged from the fan 150 may be alternately changed so that the discharged air does not have directivity to be biased to one side and accordingly, the air with even fluidity may be provided over the entire cooking chamber 20.

A flow of the air changing according to the driving of the fan 150 will be described.

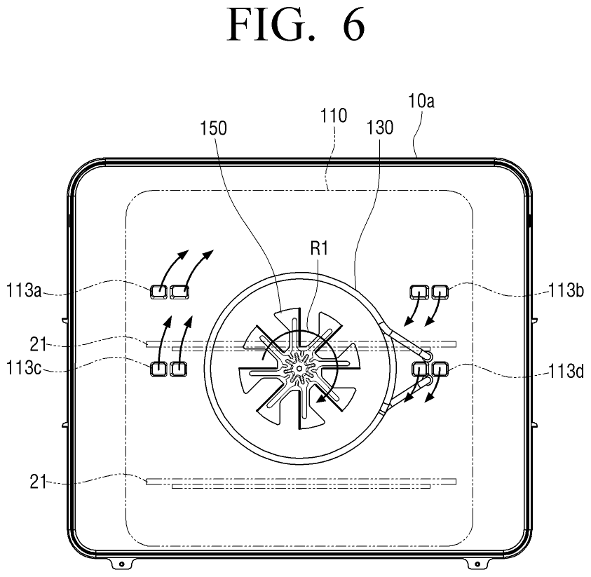

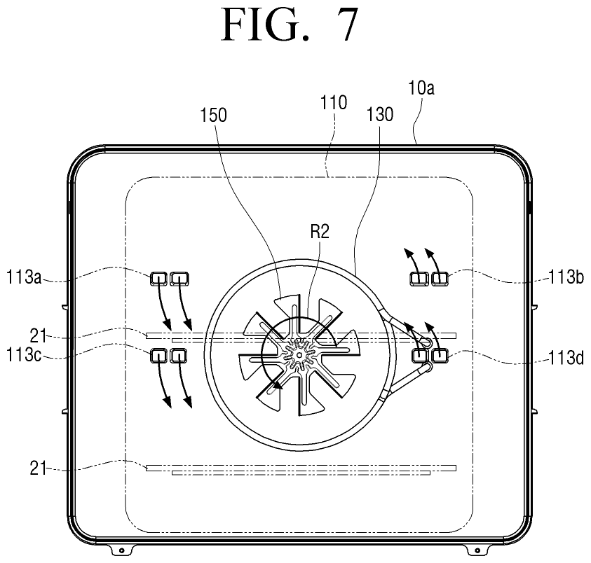

FIG. 6 is a schematic view illustrating a flow of air discharged, when the fan rotates in the first direction according to an embodiment, and FIG. 7 is a schematic view illustrating a flow of the air discharged, when the fan rotates in the second direction according to an embodiment.

Referring to FIG. 6, the air heated by the heater 130 in the chamber space 115 may be supplied into the cooking chamber 20 as the hot air via the outlet 113 by the rotation of the fan 150, and the food may be heated and cooked by the air supplied into the cooking chamber 20.

Referring to FIG. 6, when the fan 150 rotates in the first direction R1, the surrounding air of the blades 153 of the fan 150 may be discharged in a direction determined based on a combination of a centrifugal force and intensity in the rotation direction.

The air discharged to the cooking chamber 20 via the outlet 113 may have directivity. Specifically, the air supplied from the outlets 113b and 113d positioned on the right side of the fan 150 may be discharged in a direction of the tray 21, on which the food is placed, and the air supplied form the outlets 113a and 113c positioned on the left side of the fan 150 may be discharged upwards of the tray 21, on which the food is placed.

Meanwhile, referring to FIG. 7, when the fan 150 rotates in the second direction R2, the air supplied from the outlets 113a and 113c positioned on the left side of the fan 150 may be discharged in the direction of the tray 21, on which the food is placed, and the air supplied form the outlets 113b and 113d positioned on the right side of the fan 150 may be discharged upwards of the tray 21, on which the food is placed.

The air discharged to the cooking chamber 20 via the outlets 113 may have directivity. The fan 150 according to an embodiment of the disclosure may rotate by alternately changing the discharge direction so that the heating stains are not generated on the food contained in the cooking chamber 20 due to the air having the directivity.

Since the fan 150 changes the discharge direction of the air supplied to the cooking chamber 20 by alternately rotating, the temperature and the speed distributions of the air supplied into the cooking chamber 20 may be set even by alleviating the directivity of the discharged air. Therefore, the temperature and speed of the air supplied into the cooking chamber 20 may become even bilaterally, thereby preventing generation of heating stains on the food.

Meanwhile, as described above with reference to FIG. 5, the energy efficiency when the fan 150 rotates in the first direction R1 which is the direction of the vertical portion 155 is higher than the energy efficiency when the fan 150 rotates in the second direction R2 which is the direction of the empty portion 157. Accordingly, in order to increase the energy efficiency of the cooking device 1 according to an embodiment of the disclosure, the fan 150 may rotate so that a rotation time in the first direction R1 is longer than a rotation time in the second direction R2.

Hereinafter, the operation of the fan 150 will be described in detail.

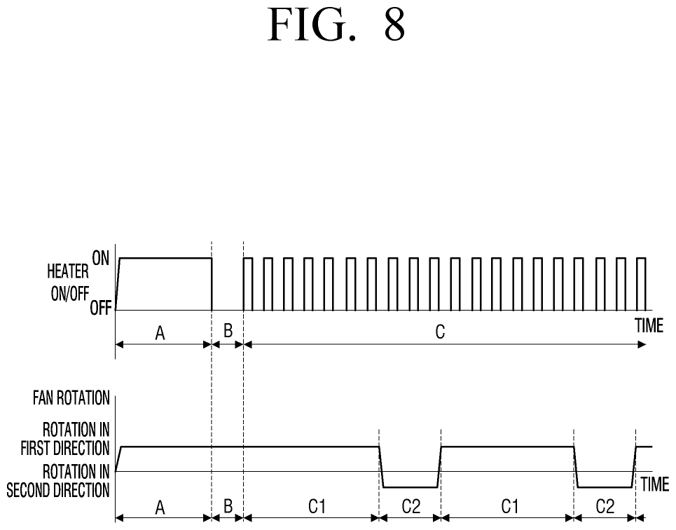

FIG. 8 is a graph illustrating operations of the fan and the heater according to an embodiment.

Referring to FIG. 8, the food is contained in the cooking chamber 20 of the cooking device 1 and the cooking device 1 may start cooking.

After starting cooking, if the temperature of the cooking chamber 20 is increased once to a set cooking temperature through a preheating process A, the inside of the cooking chamber 20 may be maintained at the set cooking temperature until the cooking is completed.

The heater 130 may be turned on during the preheating process A, and if the temperature of the cooking chamber 20 is equal to or higher than the set temperature, the heater 130 may be turned off and stop driving during a resting process B. Then, the heater 130 may maintain the set temperature of the cooking chamber 20 by repeating to be turned on and off until the cooking is completed (C).

During the preheating process A, the fan 150 may be driven to rotate in the first direction R1 so as to more rapidly perform initial preheating of the cooking chamber 20. Since the energy efficiency of the rotation of the fan 150 in the first direction R1 is higher than the energy efficiency of the rotation thereof in the second direction R2, the processor 120 may control the motor 160 so that the fan 150 rotates in the first direction R1 during the preheating process A.

During the resting process B in which the driving of the heater 130 is stopped, the fan 150 may rotate in the first direction R1 in order to circulate the air inside of the cooking chamber 20. In order to increase the energy efficiency of the cooking device 1, the processor 120 may control the motor 160 so that the fan 150 rotates in the first direction R1 during the resting process B.

In the preheating process A and the resting process B, it is more important to rapidly increase the temperature of the inside of the cooking chamber 20 rather than to set the temperature of the inside of the cooking chamber even, and accordingly, it is advantageous to not control the direction of the fan 150 so as to supply an amount of heat into the cooking chamber 20 as much as possible.

After the resting process B, the fan 150 may alternately rotate in the first direction R1 and the second direction R2 during a temperature controlling process C.

The fan 150 may rotate in the first direction R1 during a first time C1 and rotate in the second direction R2 during a second time C2. Referring to FIG. 8, it is illustrated that the fan 150 rotates in the first direction R1 and then rotate in the second direction R2, but there is no limitation thereto, and the fan 150 may rotate in the second direction R2 during the second time C2 and then rotate in the first direction R1 during the first time C1.

Since the rotation of the fan 150 in the first direction R1 and the rotation thereof in the second direction R2 are performed alternately, the temperature distribution and the speed distribution of the air supplied to the cooking chamber 20 may become even at both right and left sides, and accordingly, the heating stains may be prevented from being generated on a plurality of foods placed in the cooking chamber 20.

The fan 150 may rotate in the first direction R1 for a period of time longer than the time C2 during which the fan 150 rotates in the second direction R2.

The processor 120 may control the motor 160 so that the retention time C1 during which the fan 150 rotates in the first direction R1 is longer than the retention time C2 during which the fan 150 rotates in the second direction R2, and so that the first time C1 is longer than the second direction C2.

Specifically, the fan 150 may rotate so that the retention time C1 in the first direction R1 is two or more times longer than the retention time C2 in the second direction R2. More preferably, the fan 150 may rotate so that a ratio of the retention time C1 in the first direction R1 to the retention time C2 in the second direction R2 is 7/3 or more.

In addition, the fan 150 may repeat the rotation in the first direction and the rotation in the second direction during the temperature controlling process C on a predetermined cycle. The fan 150 may repeat the alternate rotation including the rotation in the first direction R1 and the rotation in the second direction R2 at least two or more times.

During the temperature controlling process C, the heating stains may be generated on the surface of the food due to the discharged air, and accordingly, the processor 120 may control the rotation direction of the fan 150 so as to supply the horizontally balanced air to the cooking chamber 20.

The processor 120 may control the motor 160 so that the retention time C1 of the fan 150 in the first direction R1 is longer than the retention time C2 thereof in the second direction R2. Specifically, the processor 120 may control the motor 160 so that the retention time C1 of the fan 150 in the first direction R1 is two or more times longer than the retention time C2 in the second direction R2, and more preferably, the processor 120 may control the motor 160 so that the ratio of the retention time C1 of the fan 150 in the first direction R1 to the retention time C2 of the fan 150 in the second direction R2 is 7/3 or more.

The fan 150 may minimize the rotation in the second direction R2 to minimize the decrease in energy efficiency due to the rotation in the second direction R2. Therefore, the energy performance of the cooking device 1 may be maintained.

In addition, due to such rotation of the fan 150, the speed of the air on the entire surface of the food regarding each of the plurality of foods may be measured evenly as 0 to 0.5 m/s. According to such results, it is understood that the generation of the heating stains on the food is prevented.

In addition, the processor 120 may control the motor 160 so that the fan 150 changes the rotation direction before the heater 130 is turned on. In other words, the heater 130 may be turned on, when the fan 150 is completely stopped and changed the rotation direction. Accordingly, it is possible to prevent an excessive increase in temperature when the wind speed in the direction of the cooking chamber 20 decreases.

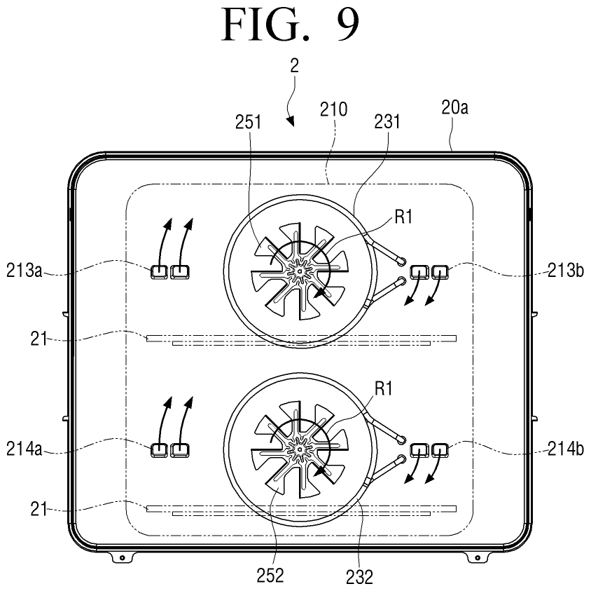

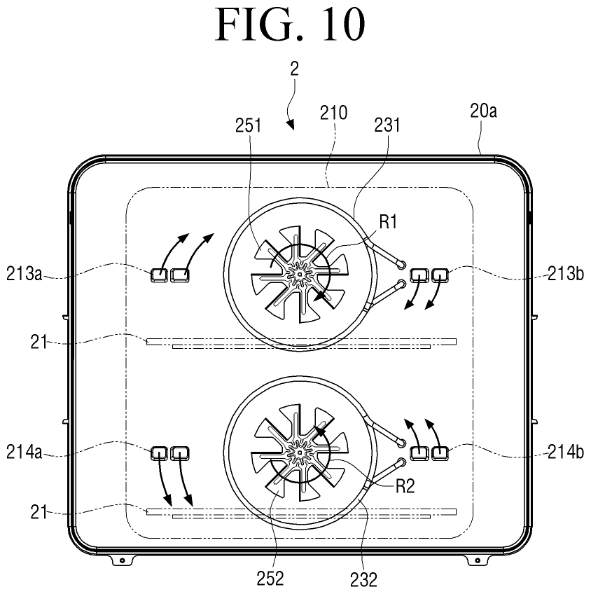

FIG. 9 is a schematic view illustrating a flow of the air discharged, when fans rotate in the same direction according to another embodiment and FIG. 10 is a schematic view illustrating a flow of the air discharged, when the fans illustrated in FIG. 9 rotate in different directions.

Referring to FIGS. 9 and 10, a cooking device 2 according to another embodiment of the disclosure may have the same configuration for most of parts of the cooking device 1 described with reference to FIG. 6, however, there is a difference in that a plurality of fans 251 and 252 and a plurality of heaters 231 and 232 are provided. Accordingly, the configuration of the cooking device 2 according to another embodiment of the disclosure that is overlapped with the cooking device 1 described with reference to FIG. 3 in the same manner will be not repeated, and the driving of the fans 251 and 252 with the difference therefrom will be described.

The fans 251 and 252 and the heaters 231 and 232 may be provided with a plurality of pieces. The fans 251 and 252 and the heaters 231 and 232 surrounding the fans 251 and 252 may be disposed vertically symmetrical to each other.

The cover 210 for covering the fans 251 and 252 may include an inlet (not illustrated) and outlets 213a, 213b, 214a, and 214b.

The upper outlets 213a and 213b may be formed to be bilaterally symmetrical on an outer portion of the upper fan 251 and the lower outlets 214a and 214b may be formed to be bilaterally symmetrical on an outer portion of the lower fan 252.

Referring to FIG. 9, the upper fan 251 and the lower fan 252 may rotate in the same direction. The processor 120 may control a motor (not illustrated) so that the upper fan 251 and the lower fan 252 rotate in the same direction.

In the same manner as the fan 150 described with reference to FIG. 6, the upper fan 251 and the lower fan 252 may selectively change the discharge direction of the air heated by the heaters 231 and the 232 and provide the heated air to the cooking chamber 20. The processor 120 may control the motor (not illustrated) so that the fans 251 and 252 alternately change the discharge direction, and may control the motor so that a retention time in a predetermined discharge direction among a plurality of discharge directions is longer than a retention time in another discharge direction. The predetermined discharge direction may be a rotation direction with higher energy efficiency than the other discharge direction.

Specifically, the fans 251 and 252 may rotate in the first direction R1 so that the initial preheating of the cooking chamber 20 is more rapidly performed during the preheating process A and the resting process B, and the fans 251 and 252 may rotate in the first direction R1 and the second direction R2 alternately during the temperature controlling process C.

The fans 251 and 252 may rotate in the first direction R1 during the first time C1 and rotate in the second direction R2 during the second time C2. The fans 251 and 252 may rotate in the first direction R1 for a period of time longer than the time C2 during which the fans rotate in the second direction R2.

Specifically, the fans 251 and 252 may rotate so that the retention time C1 in the first direction R1 is two or more times longer than the retention time C2 in the second direction R2. More preferably, the fans 251 and 252 may rotate so that a ratio of the retention time C1 in the first direction R1 to the retention time C2 in the second direction R2 is 7/3 or more.

Meanwhile, referring to FIG. 10, the upper fan 251 and the lower fan 252 may rotate in different directions. The processor 120 may control the motor (not illustrated) so that the upper fan 251 and the lower fan 252 rotate in different directions.

Specifically, during the temperature controlling process C, the fans 251 and 252 may rotate in the first direction R1 and the second direction R2 alternately. The upper fan 251 and the lower fan 252 may be driven independently from each other.

During the temperature controlling process C, the upper fan 251 may first rotate in the first direction R1 during the first time C1 and rotate in the second direction R2 during the second time C2, and the lower fan 252 may first rotate in the second direction R2 during the second time C2 and then rotate in the first direction R1 during the first time C1. The fans 251 and 252 may rotate in the first direction R1 for a period of time longer than the time C2 during which the fans rotate in the second direction R2.

Specifically, the fans 251 and 252 may rotate so that the retention time C1 in the first direction R1 is two or more times longer than the retention time C2 in the second direction R2. More preferably, the fans 251 and 252 may rotate so that the ratio of the retention time C1 in the first direction R1 to the retention time C2 in the second direction R2 is 7/3 or more.

Meanwhile, both the upper fan 251 and the lower fan 252 may rotate in the first direction R1 so that the initial preheating of the cooking chamber 20 is more rapidly performed during the preheating process A and the resting process B.

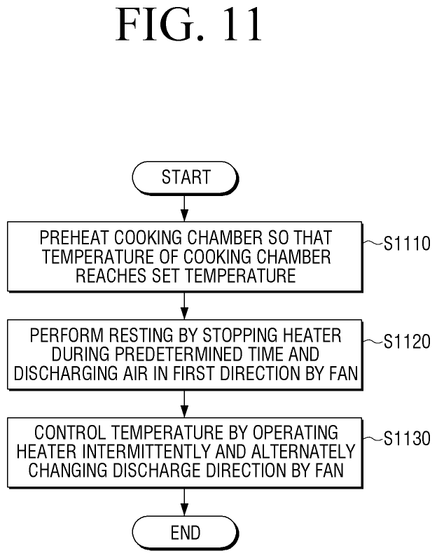

FIG. 11 is a flowchart illustrating a method for controlling the cooking device according to an embodiment.

Referring to FIG. 11, the cooking device 1 according to an embodiment of the disclosure may be preheated so that the temperature of the cooking chamber 20 reaches a set temperature (S1110). In such a preheating step, the heater 130 may be maintained to be turned on and the fan 150 may discharge the air in the first direction R1, in order to rapidly perform the initial preheating of the cooking chamber 20. The first direction R1 is a rotation direction of the fan 150 with higher energy efficiency than the second direction R2.

If the cooking chamber 20 reaches the set temperature, during a resting step S1120, the heater 130 may stop and the fan 150 may discharge the air in the first direction (S1120). The retention time of the resting process may be determined according to whether the door 11 is opened or closed. If the door 11 is not opened during the resting process, the resting process may be performed for approximately 10 minutes.

Meanwhile, when the door 11 is opened for additionally supplying the food during the resting process, the resting process may be performed for approximately 10 minutes after the door is opened and closed.

The method for controlling the cooking device 1 may include a temperature controlling step S1130 for maintaining the temperature of the cooking chamber 20 constant after the resting process. In the temperature controlling step S1130, the heater 130 may be intermittently operated by repeating to be turned on and off.

In the temperature controlling step, the fan 150 may change the discharge direction alternately. Specifically, the fan 150 may change the rotation direction to the first direction R1 and the second direction R2 alternately.

The fan 150 may rotate in the first direction R1 for a period of time longer than the rotation in the second direction R2. Specifically, the fan 150 may rotate so that a rotation retention time in the first direction R1 is two or more times longer than a rotation retention time in the second direction R2, and preferably, the fan 150 may be driven so that a ratio of the rotation time in the first direction R1 to the rotation time in the second direction R2 is 7/3 or more.

The fan 150 may change the rotation direction before the heater 130 is turned on, and the heater 130 may be operated when the fan 150 is driven, so that the heated air may be provided to the cooking chamber 20 efficiently, thereby increasing the energy efficiency.

Since the fan 150 repeatedly rotates in the first direction and the second direction alternately, the temperature distribution and the speed distribution of the air provided to the cooking chamber 20 may be maintained evenly at both right and left sides. Therefore, it is possible to prevent the heating stains which may be generated on the food. In addition, since the fan 150 rotates so that the rotation retention time in the first direction is longer than the rotation retention time in the second direction, the energy efficiency of the cooking device 1 may be further increased.

Hereinabove, the disclosure has been described by the exemplified method. The terms used herein are for description and should not be understood as limited meanings. The various changes and modifications of the disclosure can be made depending on the content. Therefore, unless otherwise noted, the disclosure may be freely practiced within the scope of claims.

1. A cooking device comprising:
a main body in which a cooking chamber including an inlet and an outlet is formed;
a heater configured to heat the air;
a fan configured to provide the heated air to the cooking chamber by selectively changing a discharge direction; and
a processor configured to control a motor configured to provide a driving force to the fan so that the fan alternately changes the discharge direction,
wherein the processor is configured to control the motor so that a retention time in a predetermined discharge direction among a plurality of discharge directions is longer than a retention time in another discharge direction.

2. The cooking device according to claim 1, wherein the predetermined discharge direction is a direction according to rotation of the fan in a first direction, and the other discharge direction is a direction according to rotation of the fan in a second direction opposite to the first direction.

3. The cooking device according to claim 2, wherein the fan comprises:
a rotation plate configured to be located to be adjacent to one side of the main body and a center portion of which is fastened to a motor for driving the fan; and
a plurality of blades radially extending from the rotation plate,
wherein each of the plurality of blades comprises:
a vertical portion configured to be formed on one side to be vertical to the rotation plate; and
an empty space configured to be formed on the other side,
wherein the first direction is a direction of the vertical portion, and
wherein the second direction is a direction of the empty space.

4. The cooking device according to claim 3, wherein the processor is configured to control the motor so that a retention time in the first direction is two or more times longer than a retention time in the second direction.

5. The cooking device according to claim 3, wherein the processor is configured to control the motor so that the discharge direction of the fan alternately changes two or more times in a predetermined section.

6. The cooking device according to claim 5, wherein the processor is configured to control the motor so that the fan rotates in the first direction before the predetermined section until a temperature of the cooking chamber reaches a set preheating temperature.

7. The cooking device according to claim 6, wherein the processor is configured to:
based on the temperature of the cooking chamber reaching the set preheating temperature, control the motor so that the fan rotates in the first direction during a predetermined time; and
based on the predetermined time being elapsed, control the motor so that the fan alternately changes the discharge direction during the predetermined section.

8. The cooking device according to claim 3, wherein the fan is configured to discharge the air flowing in an axial direction of the rotation plate in a circumferential direction of the plurality of blades.

9. The cooking device according to claim 3, further comprising:
a cover configured to form a space partitioned from the cooking chamber in the main body and cover the heater and the fan,
wherein the inlet and outlet are formed on the cover.

10. The cooking device according to claim 9, wherein the inlet is formed in a circular shape at a position corresponding to the center portion of the rotation plate, and
wherein the outlet is formed bilaterally symmetrical with respect to the inlet.

11. The cooking device according to claim 3, wherein the vertical portion is formed by folding one side of each of the plurality of blades, and the plurality of empty spaces are formed by the folded vertical portions.

12. A method for controlling an electronic device, the method comprising:
preheating a cooking chamber so that a temperature of the cooking chamber including an inlet and an outlet reaches a set temperature;
performing resting by stopping a heater for heating the air during a predetermined time, and discharging the air in a first direction by the fan for providing the heated air to the cooking chamber, in order to circulate the air inside of the cooking chamber; and
controlling a temperature by operating the heater intermittently in order to maintain a temperature of the inside of the cooking chamber constant,
wherein, in the controlling the temperature, the fan alternately changes a discharge direction and a retention time in a predetermined discharge direction among a plurality of discharge directions is longer than a retention time in another discharge direction.

13. The method according to claim 12, wherein the predetermined discharge direction is a first direction of a circumferential direction of the fan and the other discharge direction is a second direction opposite to the first direction, and
wherein, in the controlling the temperature, a first direction rotation time of the fan is two or more times longer than a second direction rotation time of the fan.

14. The method according to claim 12, wherein, in the controlling the temperature, the fan changes a rotation direction before the heater is operated.

15. The method according to claim 12, wherein, in the preheating, the heater is continuously operated and the fan rotates in the first direction.
